(19) United States
(12) Patent Application Publication
(10) Pub. No.: US 2012/0310899 A1
(43) Pub. Date: Dec. 6, 2012

(54) SYSTEM AND METHOD FOR EFFICIENT DATA EXCHANGE IN A MULTI-PLATFORM NETWORK OF HETEROGENEOUS DEVICES

(76) Inventors: Scott Lawrence Wasserman, Philadelphia, PA (US); Daniel E. Koch, Philadelphia, PA (US)

(21) Appl. No.: 13/487,924

(22) Filed: Jun. 4, 2012

Related U.S. Application Data
(60) Provisional application No. 61/492,865, filed on Jun. 3, 2011.

(51) Int. Cl. G06F 17/30

(52) U.S. Cl. 707/687; 707/E17.127; 707/E17.032

(57) ABSTRACT

A normalization engine, system and method provide normalization of and access to data between heterogeneous data sources and heterogeneous computing devices. The engine includes connectors for heterogeneous data sources, and conduits for gathering a customized subset of data from the data sources, as required by a software application with which the conduit is compatible. Working together, the connector and conduit may gather large amounts of data from multiple data sources and prepare a subset of the data that includes only that data required by the application, which is particularly advantageous for mobile computing devices. Further, the conduit may process the subset data in various formats to provide normalized data in a single format, such as a JSON-formatted REST web service communication compatible with heterogeneous devices. As an intermediary, the normalization engine may further provide caching, authentication, discovery and targeted advertising to mobile computing and other computing devices.

### CROSS-REFERENCE TO RELATED APPLICATIONS

This application claims the benefit of priority under 35 U.S.C. §119(e) of U.S. Provisional Patent Application No. 61/492,865, filed Jun. 3, 2011, the entire disclosure of which is hereby incorporated herein by reference.

### FIELD OF THE INVENTION

The present invention relates generally to information access and exchange of data among and across heterogeneous computing devices, and, more particularly, to engines, systems and methods for retrieving, aggregating, selecting and/or normalizing data in a heterogeneous multi-platform computing environment.

### DISCUSSION OF RELATED ART

In the present commercial environment, there are numerous manufacturers of microprocessor-based computing devices, and many different operating systems available to run such devices. Each different OS and/or device provides a different computing platform. Although some open source operating systems exist, the majority of computers, mobile phones and consumer electronics run proprietary software. As a result, the marketplace includes devices that are heterogeneous, and thus are often are inefficient in and/or incapable of communicating with each other and/or certain data sources, at least in certain data transfer modes.

As a result, development of software applications for such computing devices often requires repeated redesign of applications so that they may be used on each of the various devices or operating systems/platforms. For example, a programmer wishing to create an application must often choose to build the application for a specific operating system and/or platform. But, if more than one operating system is targeted, the programmer must generally rebuild the application “from the ground up” to ensure proper functionality with each additional targeted operating system.

Thus, there is a need for a system that allows for applications and/or data in different formats to be used compatibly with heterogeneous devices having different operating systems or platforms. More particularly, there is a need for an engine, system and method for normalizing data in a multi-platform information infrastructure, and for providing access to, sending of, and receipt of content developed, for use with computers, smart mobile telephones (“smartphones”) and other electronic computing devices and the various operating systems resident thereon in an efficient and/or controlled manner.

### SUMMARY OF THE INVENTION

The present invention provides an engine, system and method for providing normalized communications and data access between alternative platform systems and devices. Such normalization allows for exchange of data among heterogeneous data sources and/or client devices. Further, the present invention provides an engine, system and method that can gather and aggregate data from multiple data sources, and/or select only a required subset of gathered data for transmission to devices, normalize the data for efficient consumption, e.g., by converting its format for consumption by heterogeneous devices, before exposing it to the network for consumption by heterogeneous devices. When communicating to devices in a mobile communications network, it is advantageous to convert the data to a JSON-formatted communication and to expose the JSON data via a REST web service. Performance of these functions is particularly advantageous when such selecting is performed at a point intermediate high-resource and low-resource portions of a communications network, because it allows for efficient use resources in lower-resource environments. The present invention thus provides a special-purpose information appliance configured to operate within a network to facilitate efficient communication between disparate computing devices and systems, including heterogeneous data sources and heterogeneous client devices.

A computer-implemented method for normalizing data for cross-platform consumption includes providing a normalization engine for normalizing data for cross-platform consumption, the normalization engine comprising a computer processor operatively connected to a memory for storing processor-executable instructions, and to a network adapter for communicating data via a communications network; providing a normalization engine for normalizing data for cross-platform consumption, the normalization engine comprising a computer processor operatively connected to a memory for storing processor-executable instructions, and to a network adapter for communicating data via a communications network; receiving data at the normalization engine via the communications network; processing data, at the normalization engine, to provide normalized data in a predetermined fashion compatible with a plurality of heterogeneous devices; and exposing the normalized data, for transmission by the network adapter via the communications network.

A normalization engine for normalizing data for cross-platform consumption comprises at least one data source-specific connector, each data source-specific connector being configured to exchange data via a communications network with at least one data source; and at least one software application-specific conduit, each application-specific conduit being configured to communicate with at least one connector, and to exchange data via a communications network with at least one of a plurality of heterogeneous client computing devices, each application-specific conduit comprising instructions for processing received data to provide normalized data in a predetermined fashion compatible an intended recipient of the data, and for exposing the normalized data via the communications network.

A content server for normalizing data for cross-platform consumption comprises a microprocessor for executing microprocessor-executable instructions; a network adapter operatively connected to the microprocessor for communicating data via a communications network; a memory operatively connected to the microprocessor for communication therewith, the memory storing microprocessor-executable instructions for causing the content server to: receive data at the content server via the communications network, the received data being incompatible with a plurality of devices intended to receive the data; process, at the content server, the data to provide normalized data in a predetermined fashion compatible with the plurality of devices; and transmit, from the content server via the communications network, the normalized data to at least one of the plurality of devices.

A system for normalizing data for cross-platform consumption comprises a plurality of heterogeneous client devices, each of the plurality of heterogeneous client devices storing a software application for consuming data from data sources; and a content server.

It is to be understood that both the foregoing general description and the following detailed description are exemplary and explanatory, and are intended to provide further explanation of the invention as discussed herein.

### BRIEF DESCRIPTION OF THE DRAWINGS

The present invention will now be described by way of example with reference to the following drawings in which:

FIG. 1 is a block diagram of an exemplary embodiment of a system in accordance with the present invention, showing an exemplary content server disposed within a public network and interposed logically between an unsecured data source and supported client devices;

FIG. 2 is a block diagram of an exemplary embodiment of an alternative system in accordance with the present invention, showing an exemplary content server disposed within a private network and interposed logically between a secured data source and supported client devices;

FIG. 3 is a block diagram showing in greater detail a normalization engine in accordance with an exemplary embodiment of the present method;

FIG. 4 is a block diagram showing an alternative normalization engine in accordance with an alternative exemplary embodiment of the present invention;

FIG. 5 is a flow diagram illustrating a method for normalizing data in accordance with an exemplary embodiment of the present invention;

FIG. 6 is a flow diagram illustrating a method for normalizing data in accordance with an alternative embodiment of the present invention; and

FIG. 7 is a block diagram of an exemplary content server.

### DETAILED DESCRIPTION

The present invention provides an engine, system and method for providing normalized communications and data access between heterogeneous client devices having different hardware and/or software, such as operating system software. Such normalization involves conversion of data to a common communication format providing compatibility among devices, such as between data sources and client computing devices, for which communication might otherwise be impossible for inefficient. Such normalization may allow for the adaptation and development of applications and cloud-based services for interchangeable use between third parties' heterogeneous client devices.

Further, the present invention allows for placement of the inventive normalization engine logically between, for example, different networks having different bandwidth, connectivity or other characteristics. In such embodiments, the normalization may not only enable communication among otherwise incompatible devices, but may also enhance data, transmission and/or network efficiency by gathering data via a higher-resource network, selecting a subset of gathered data at the normalization engine, and then transmitting via the lower-resource network only the particular subset of data required by a client device in the lower-resource network. Thus, the normalization engine effectively offloads transmission and/or processing burdens from client devices and networks having relatively lesser resources to devices and/or networks having relatively greater resources.

Further still, the logical interposition of the normalization engine between a data source and a client device and the normalization engine's role as an intermediary and conduit for consuming data from the data source provides opportunities for further network efficiency by caching data that may be used by other devices, for providing enhanced access control to data on a per-device basis, based on authentication of each client device, and for delivering targeted, personalized advertising on a per-device basis. By way of example, such advertising may be delivered as a function of user profile data received and/or observed on a per-device basis, e.g., in connection with an authentication process carried out by the normalization engine. By way of alternative example, such advertising may be delivered as a function of a device type, of a source or type of data requested and/or consumed, or of a location of the device as reflected in geographical location data associated with the device or communication with the device.

The normalization engine and content server, systems and method disclosed herein are of a type that may be implemented in virtually any networked computing environment, and thus have broad application. By way of example, the engine, server, systems and methods disclosed herein are of a type that may be used to provide networked access to a plurality of types of digital content, including but not limited to video, audio, and document content, and that track and deliver the accessed content, such as via one or more applications, or “apps.”

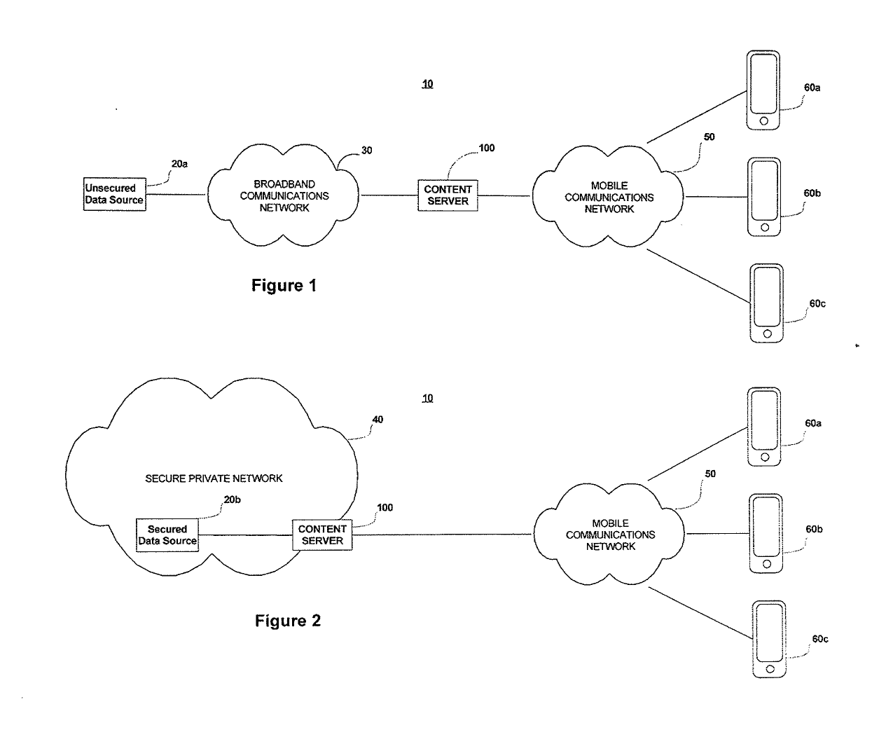

For illustrative purposes only, exemplary embodiments are shown in FIGS. 1-4 and described herein in the context of conventional broadband and conventional mobile communications networks, with reference to mobile telephones, smartphones, tablet PCs and other “mobile” computing devices. However, these embodiments are intended to be exemplary only and not limiting. As such, it is contemplated that the systems and methods described herein can be adapted to provide many different types of users and computing devices with access to and delivery of many different types of domain data, and can be extended to provide enhancements and/or additions to the exemplary services described, which are within the scope of the present invention.

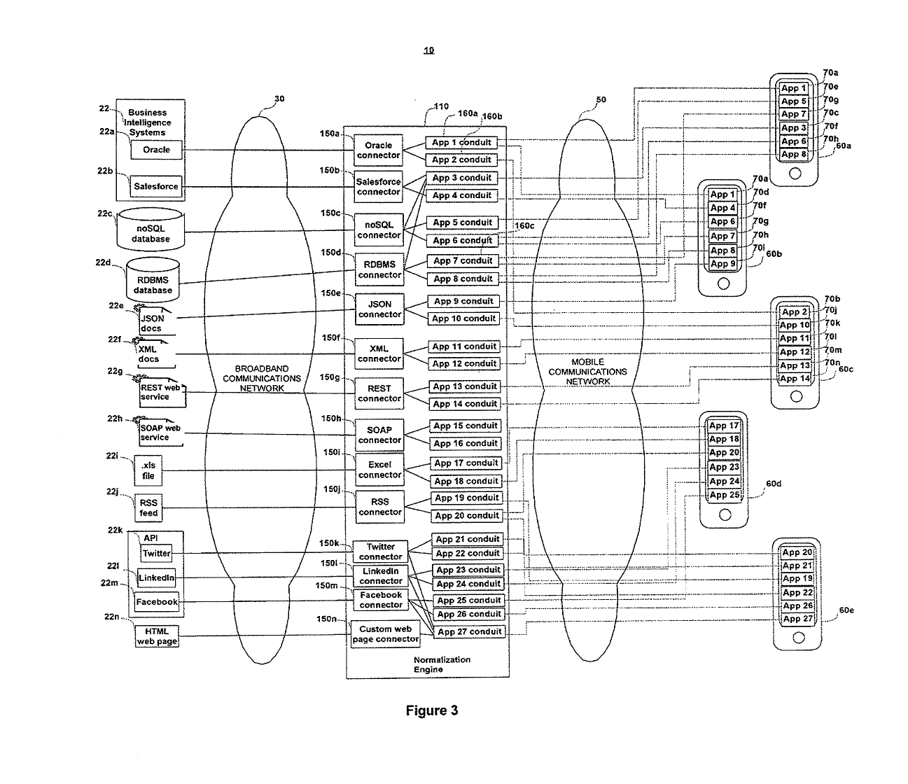

Reference will now be made in detail to various exemplary and illustrative embodiments of the present invention. Referring now to FIG. 1, a diagram of an exemplary networked computing environment 10 including an content server 100 (including a normalization engine 110 shown in FIG. 3) in accordance with the present invention is shown. In this exemplary network 10, the content server 100 is shown disposed within a public network and interposed logically between an unsecured data source 20a and a plurality of heterogeneous client devices 60a, 60b, 60c.

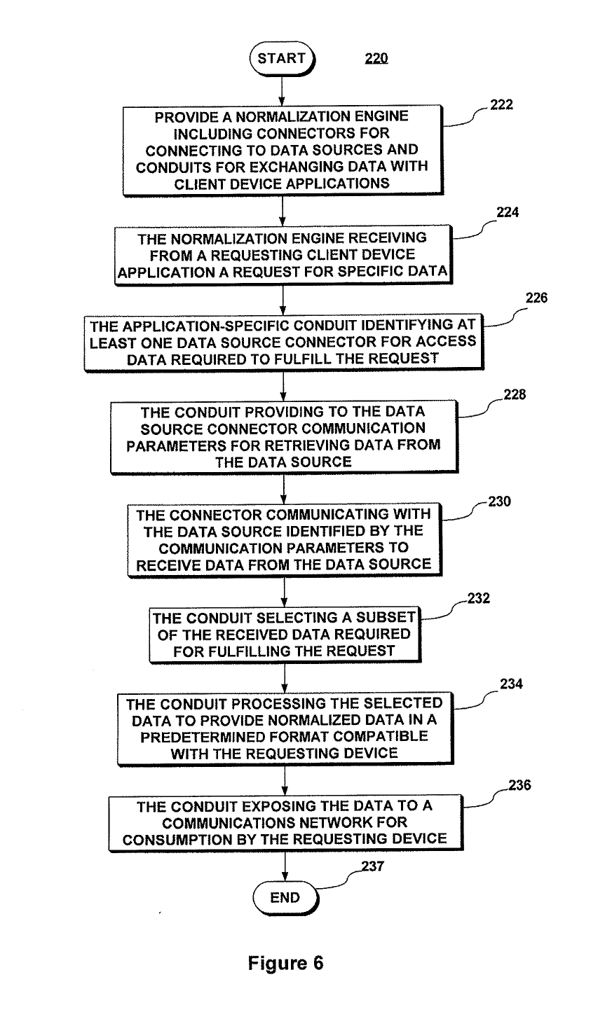

It should be appreciated however that the term “content server” as used herein is not limiting and applies equally to client/server computing environments and other network communications among computing devices. A detailed discussion of an exemplary computing system is provided below with reference to FIG. 6, and it applies to servers, clients and peer computers deployed in a network environment, for example, a server, laptop computer or desktop computer.

In this embodiment, for example, the content server 100 may be used to retrieve/receive data from data sources 20a by communicating via the communications network 30 using conventional communications technologies. Further, exchange of data via the content server is bidirectional, and thus by way of further example, the content server 100 (and its normalization engine 110, FIG. 3) may be used not only to receive data from the data sources 20a, 20b (FIG. 1), and 22a-22n (FIG. 3), but also to transmit data to the data sources 20a, 20b, 22a-22n.

Accordingly, the content server 100 may be interconnected to the data sources via a communications network (which may include any of, or any combination of, a fixed-wire or wireless LAN, WAN, intranet, extranet, peer-to-peer network, virtual private network, the Internet, or other communications network such as POTS, ISDN, VoIP, PSTN, etc.). Content server 100 can comprise dedicated servers operable to process and communicate data such as digital content to and from the data sources 20a, 20b, 22a-22n using any of a number of known protocols, such as hypertext transfer protocol (HTTP), file transfer protocol (FTP), simple object access protocol (SOAP), wireless application protocol (WAP), or the like. Optionally, networked computing environment 10 can utilize various data security protocols such as secured socket layer (SSL), pretty good privacy (PGP), virtual private network (VPN) security, or the like.

Further, the content server 100 may be used to exchange data with heterogeneous client devices 60a, 60b, 60c, etc. via a communications network, such as communications network 50. Such data exchange may be made using conventional communications technologies. Further, such exchange of data via the content server is bidirectional, and thus by way of further example, the content server 100 (and its normalization engine 110, FIG. 3) may be used not only to transmit data to the client devices 60a, 60b, 60c, but also to receive data from the client devices 60a, 60b, 60c. Accordingly, the content server may exchange data with a number of client computing/communication devices such as laptop computers, wireless mobile telephones, wired telephones, personal digital assistants, user desktop computers, and/or other communication enabled devices (not shown).

In accordance with the present invention, communications between the content server 100 and client devices 60a, 60b, 60c are made in a fashion that is widely-supported by many heterogeneous client devices. In one embodiment, such communications are made with REST web services, e.g. via the HTTP(S) communications protocol.

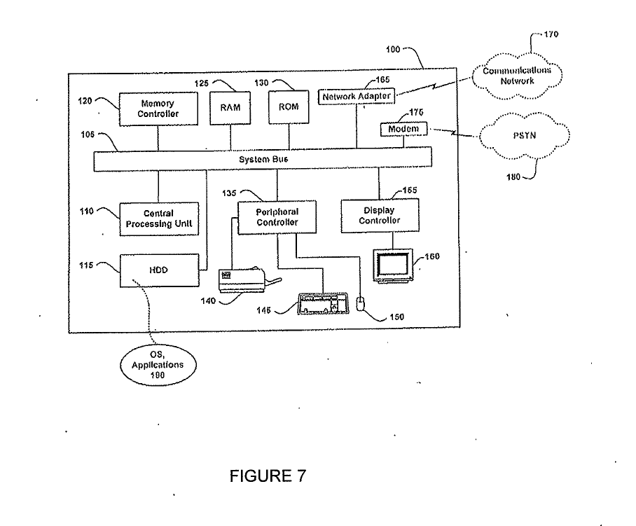

A detailed discussion of an exemplary computing system is provided below with reference to FIG. 7, and it applies to servers, clients and peer computers deployed in a network environment, for example, a server, laptop computer or desktop computer.

The heterogeneous client devices 60a, 60b, 60c may be any computing device configured for communicating via a communications network. Heterogeneous client devices may include distinctly different hardware and/or software, such as different operating system software. By way of example, a client device 60a, 60b, 60c may be any mobile telephone, PDA, tablet or smart phone and may have any device compatible operating system. Such operating systems may include, for example, Symbian®, RIM Blackberry® OS, Android®, Apple® iOS, Windows® Phone, Palm® webOS, Maemo, bada, MeeGo, Brew OS, and Linux for smartphones and tablets. Although many mobile operating systems may be programmed in C++, some may be programmed in Java and .NET, for example. Some operating systems may or may not allow for the use of a proxy server and some may or may not have on-device encryption. Examples of heterogeneous client computing devices include mobile telephones such as Nokia® Asha mobile phones running the Nokia® Series 40 OS software, smartphones such as the Apple® iPhone running iOS software, Samsung® Galaxy Nexus phones running Android® OS, HTC® Titan II phones running Windows® Phone 7 OS software, tablet PCs such as the Apple® iPad® and Blackberry® Playbook 2, laptop computers such as PCs running Windows OS software, PCs running Unix-based operating systems such as Macintosh® OS X, and even CATV set top boxes, smart refrigerators, and game and home entertainment devices, such as the Microsoft® Xbox 360.

Each client device 60a, 60b, 60c, etc. can be equipped with an operating system operable to support one or more computing and/or communication applications, such as a web browser (not shown), email (not shown), or independently developed applications, to interact with content server 100.

Conventional communications between such devices have been characterized by a certain lack of programming language, device, network and/or data efficiency that is commonplace but generally acceptable particularly in the context of a broadband communications network among resource-rich devices such as PCs.

The content server 100 is further used to process the received data to prepare it for transmission to client devices 60a, 60b, 60c in a manner that will allow for more efficient use of network 50 and/or processing resources of the client devices, e.g. by selecting for consumption by the client devices only a subset of the data available at the data sources, and/or by normalizing the data from a format or communication that may be incompatible or require more processing by the client devices to a format or communication that is compatible or requires less processing by the client devices. This is particularly advantageous, for example, when the client devices have relatively limited computational resources, such as in the case of smartphone or tablet PC client devices, and/or when the network 50 is characterized as having relatively less bandwidth or other resources, such as in the case of mobile communications networks. Example of mobile communication networks include Global System for Mobile Communication (GSM), General Packet Radio Services (GPRS), Code Division Multiple Access (CDMA) or CDMA2000 networks, third-generation (3G) networks like EDGE, HSPA, HSPA+, EVDO and UMTS, or fourth-generation (4G) networks such as LTE and LTE Advanced networks. It should be noted however that although the normalization engine provides certain advantages when used between broadband and more constricted mobile networks, the normalization environment may be used in any network, or between any networks, including between two broadband networks.

Referring now to FIG. 2, a diagram of a similar exemplary network 10 is shown. In this exemplary network 10, the content server 100 is shown disposed within a secure private network 40 and interposed logically between a secured data source 20b and a plurality of heterogeneous client devices 60a, 60b, 60c. In this embodiment, the content server 100 may perform not only the functions described above with reference to FIG. 1, but may also perform data security-related functions. For example, the content server 100 may be disposed logically at an edge of the secure private network 40, and may perform authentication functions, such that access to data from the secured data source 20b is permitted only to properly authenticated users/client devices.

In instances in which the content server is positioned logically behind a firewall of an enterprise system, only a single access port would need to be opened to allow bi-directional communication with heterogeneous client devices via the content server. In such an instance, the content server may provide full authentication and data security services on this opened access port, while all other systems behind the firewall (including internal enterprise data systems) remain fully protected by the firewall from access by the heterogeneous client devices.

Further, the arrangement described above may be advantageous in that it may be used to minimize the amount of secure data from the secured data source 20b that is permitted to exit the secure private network 40, e.g., by causing the content server 100 to select, and thus expose to the client devices 60a, 60b, 60c, only a subset of the secure data available at the secure data source 20b. This may be particularly advantageous, for example, when the underlying data relates to medical/patient data protect by HIPAA laws, sensitive financial data, or proprietary corporate data. Additionally, the content server 100 may be located entirely with a network Data Management Zone (DMZ), isolating it from the remainder of the network in the event of a data security breach. This arrangement may be advantageous in that any data security breaches caused by misconfiguration of network security policy can easily be isolated to prevent other systems within the secure private network 40 from being compromised.

The content server 100 includes a normalization engine 110 (FIG. 3) for normalizing data for cross-platform consumption by heterogeneous client computing devices. Referring now to the exemplary embodiment of FIG. 3, the exemplary normalization engine 110 is positioned logically between data sources 22a-22n and heterogeneous client computing devices 60a, 60b, 60c, 60d, 60e. More specifically, the client devices may store in their memory software applications (apps), e.g. 70a, 70e that require data from one or more of the data sources for normal operation. In this non-limiting example, the client devices are mobile computing devices such as smartphones and tablet PCs configured for communication via a mobile communications network. Technologies, hardware and software for creating, storing and executing such applications, and or communication via communications networks, are well-known in the art thus are not discussed in great detail herein.

Each data source stores data that may be consumed by the client devices. By way of example, the exemplary data sources may include data from business intelligence systems, such as the Oracle® and Salesforce® systems, data stored in relational and noSQL databases, data available as JSON-formatted or XML-formatted files/documents/web pages, data accessible via a web services such as REST or SOAP web services, data available in a comma-separated values (CSV) or other data file, data available via an RSS feed, data available via a web API, and data available as part of an HTML web page.

The normalization engine is computer-implemented using conventional computing and communication hardware specially-configured in accordance with the present invention. Consistent with the present invention, the normalization engine includes at least one data source-specific connector 150a-150n and at least one software application-specific conduit, e.g., 160a, 160b. Each data source-specific connector 150a-150n is configured to integrate with and exchange data with a corresponding data source 20a-20n via a communications network 30. Each data source-specific connector is thus specially adapted to communicate with and retrieve and/or receive data from a corresponding data source. For example, each connector may include a set of Application Programming Interfaces (APIs) that can be integrated with a specific data source or type of data source to allow the connector to use any number of services associated with the data source accessible over the network. Thus, each connector allows the normalization engine to establish an end-to-end secure, authenticated communication pipe with a particular data source (or in some instances with a particular type of data source, and in combination with communication parameter information received from the conduit with a particular data source). The connector may, for example, be configured to be aware of a schema associated with a corresponding database, or the structure and data fields provided by a particular web page.

In certain instances, a connector may be configured to be generic to many different data sources of a similar type, because those different instances share common characteristics. Such a connector is unique to a specific type of data source, but is generic as to all different data sources of the same type. In such an instance, the data source-specific connector is configured for communication with a plurality of distinct data sources of a similar data type. For example, relational databases, JSON documents, XML documents, REST and SOAP web services, CSV files, RSS feeds and the various web APIs are each examples of types of data sources for which a generic connector may be constructed and used to access many different instances of data sources of the same type, because the underlying data is structured in a particular way that can be used to advantage in designing the connector. In such instances, the connector is designed to receive communication parameters from a requesting client device and to use those communication parameters to communicate with the relevant data source. For example, the RDBMS connector is designed to receive from a specific client device an IP address, port number and account information for a specific instances of an RDBMS and the RDBMS uses those communication parameters to connect to the specific database instance identified by those communication parameters.

In other instances, a connector must be custom-configured for a specific instance of a data source, because of a lack of predictable structure of the underlying data. For example, to use an HTML web page 22n as a data source, a customized connector 150n must be developed to extract data from that specific HTML web page, in view of the unique structure of that specific web page. In this instance, the connector may not be configured to accept communication parameters but rather may include hard coding of the appropriate communication parameters.

Further, each data-source-specific connector is aware that certain actions may be executed against the underlying data in the data source and is configured for executing those actions, as necessary, against the data source. For example, the RDBMS connector 150d is aware that CREATE, GET, UPDATE and DELETE actions may be executed against the data in a relational database. By way of further example, the SOAP connector 150h can be configured to consume the Web Service Definition Language (WSDL) file of a SOAP web service data source, and to recognize that the actions defined by this WSDL file may be executed against the SOAP web service. The SOAP connector 150h will additionally recognize the data and configuration settings that must be provided to conduct these actions successfully. For actions that involve writing data back to the SOAP web service, the format of the data that needs to be supplied by the conduit (as a proxy for the client device) will be deduced from the WSDL and defined by the connector.

Thus the normalization engine 110 may be configured to store a relatively small number of connectors capable of connecting to a very large number of distinct data sources.

Any suitable hardware, software and programming may be used to provide the connectors. In one exemplary embodiment, each connector is provided as processor-executable Java code stored in the memory of the normalization engine, and the normalization engine is provided as processor-executable Ruby code stored and running on Hewlett-Packard® ProLiant server hardware running the Ubuntu Linux operating system.

Consistent with the present invention, the normalization engine 110 further includes at least one software application-specific conduit 160a, 160b, etc. In a preferred embodiment, each application-specific conduit is specially-configured for use to expose data for consumption by a specific corresponding software application 70a, 70b, 70c, etc. and/or any associated computing device. Each conduit may include instructions for selecting a subset of the received data received via at least one data source-specific connector. Each conduit accepts data from the client devices and provides instructions for causing the connector to take necessary actions on data from the data source. For example, if a relational database 22c includes 100 tables, and a certain software application 70a requires only data from a certain record of one of those tables, the application-specific conduit 160a for that application (App 1) 70a may be configured to expose for consumption by the client devices 60a, 60b using App1 70a only that certain data from that certain record of that certain database. This is achieved by configuring the App 1 conduit 160a with instructions for selecting from the received data received by the RDBMS connector 150d the specific subset of data that is required by App 1. For example, the App 1 conduit may be configured to provide instructions to the RDBMS connector 150d to tell the connector 150d to GET any row from a certain table in which ID=‘TEST.’ In this manner, all data from the RDBMS database is received by the RDBMS connector 150d at the normalization engine 110, but the connectors and conduits cooperate to select a subset of the received data, so that only the selected subset of data may be exposed for consumption by App 1 running on the various client devices.

Each application-specific conduit 160a, 160b, etc. is further specially-configured for processing the selected data to provide normalized data in a predetermined fashion that is compatible with a plurality of heterogeneous client devices, and for exposing the normalized data via a communications network. Any suitable hardware, software and programming may be used to provide the conduits. For example, each conduit may include instructions, e.g. scripting, for processing the selected data to provide normalized data as JavaScript Serialized Object Notation (JSON)-formatted data, as exposed via a Representational State Transfer (REST) web service.

As known in the art, JSON is a lightweight, text-based, language-independent data-interchange format, is based on a subset of the JavaScript Programming Language, Standard ECMA-262, 3d Edition, dated December 1999. JSON syntax is a text format defined with a collection of name/value pairs and an ordered list of values. JSON is very useful for sending structured data over wire (e.g., the Internet) that is lightweight and easy to parse. It is language and platform independent, but uses conventions that are familiar to C-family programming conventions. The JSON language is thus compatible with a great many operating systems (a list of such systems is available at www.json.org). REST is a web service architectural style that makes use of the intrinsic properties of the Hypertext Transfer Protocol (HTTP). REST is presently a dominant web service design model because of its ease of use and relationship with HTTP practices, and thus is compatible with a broad array of operating systems and applications.

Alternatively, each conduit may include instructions, e.g. scripting, for processing the selected data to provide normalized data in an eXtensible Markup Language (XML)-formatted communication, as exposed via a REST web service.

Providing the selected data as JSON-formatted or XML-formatted data exposed via a REST web service is highly advantageous because of the broad-ranging compatibility of heterogeneous devices with these types of communications, and because of the relatively compact formatting that allows for efficient processing of such communications at the client devices.

While JSON/REST and XML/REST may provide a particularly high degree of efficiency, it should be noted that in an alternative embodiment, the selected data may be normalized to an XML communication exposed using a SOAP communication protocol to provide some improved efficiency, though it is expected that efficiencies in such an arrangement will often be less than those achieved in a web services arrangement.

For example, content from a data source of statistics for an athlete in that athlete's endorsed application for a first proprietary platform of a client device may be natively provided in C++, but may be directly inaccessible by that client device due to incompatibility of C++ with the operating system of that client device. To successfully access the statistics data source, the client device may access the data via the normalization engine 110, which may provide data from the data source as JSON-formatted data via a REST web service, with which the client device is compatible. Thereby, the statistics content from the data source becomes accessible to a client device that otherwise could not have accessed the data.

The content server 100 may be configured to be aware of the client device and its capabilities. For client devices with known capabilities that impact the disposition of the data, content, or media, the content server (and attendant conduits) will make the necessary adjustments to that request. For example, if an Apple® iPad® device (which is incompatible with Adobe® Flash content) is making a request for content that would include Adobe® Flash content, the Adobe® Flash content is automatically converted to .mp4 format as part of the normalization process before being returned to the client device. Alternatively, an Android® device compatible with Adobe® Flash content may receive the Adobe® Flash content with the need for any conversion.

Any suitable hardware, software and programming may be used to provide the conduits. By way of example, each connector may be provided as Ruby or Java code stored in the memory of the normalization engine, and implement logic relevant to selecting data, converting data, accepting and passing communication parameters, performing authentication, caching and advertising functions, etc.

As mentioned above, communications via the content server and normalization engine may be bi-directional via the connectors and conduits. Accordingly, data can be not only normalized and filtered/selected for exposure for consumption by a heterogeneous client device at the normalization engine, but data can also be transmitted by a heterogeneous client device back to the conduits (e.g., via a REST web service), which then normalize the data (converting it to appropriate formats for the data sources), optionally validate it, and then submit it to multiple connectors for transmission to and/or storage in one or more data sources. For example, a particular client device may store an application that needs to submit a form to order a pizza. The normalization engine has a conduit that defines all of the data that needs to be provided by the client device to successfully order that pizza, along with the required format for that data. The application running on the client device will then submit that data in that format to the conduit via the mobile communications network 50. The conduit examines the data, validates that it is complete (e.g., complies with a predefined schema), and executes the necessary actions with the one or more connectors as necessary to store the data in the appropriate data source(s) to give effect to the ordering transaction.

It should be noted that the exemplary network environment of FIG. 3 has been simplified for illustrative purposes, and that there may be many data sources of a similar type connected or connectable to a single connector. Further, it should be appreciated that there may be many more client devices and types of client devices, and that a single application-specific conduit is configured for communicating normalized data to a plurality of heterogeneous client devices, as shown in FIG. 3 by App 1 conduit 160a which communicates with instances of App 1 70a on client devices 60a and 60b.

Further, it should be appreciated that there are many more applications, many more conduits, and many more relationships among applications, conduits and connectors than those shown in FIG. 3. For example, a single conduit such as App 3 conduit 160c may communicate with and gather data from more than one data source via more than one connector, such as Salesforce connector 150b, noSQL connector 150c, and RDBMS connector 150d. In such instances, the conduit shown logically in FIG. 3 may in fact comprise multiple distinct and/or discrete conduits, each of which is configured to communicate with a particular connector and/or data source. For example, one application may have four screens to be displayed via a computing device. Each of those four screens may be associated with its own respective conduit (for a total of four conduits) corresponding to a single app and app conduit as shown in FIG. 3. In these instances, the app-specific conduit serves an aggregation function, by aggregating data from multiple data sources and selecting the required subset of data from among the data available from the various data sources. In this instance, the conduit includes instructions for aggregating data received from a plurality of data sources, and for transmitting normalized data selected from the aggregated data to at least one of the plurality of heterogeneous client devices. For example, an e-commerce application may connect to a corresponding conduit that includes a sub-conduit for gathering transaction information from a first data source, a second sub-conduit for submitting new transaction information to create a new transaction record within the data source(s), and a third sub-conduit that gathers details of a particular inventory item from a third data source. Each sub-conduit preferably corresponds to a single REST web service, which will (a) expose normalized data in a common communication format (e.g., as JSON or XML data) as compiled and normalized from data received from one or more data sources, or (b) receive data from an application/client device (e.g., in JSON or XML format) that will then be normalized and submitted to one or more data sources through one or more actions of one or more connectors.

Thus, it should be appreciated that the structure of the normalization engine is somewhat modular in nature. This provides not only the advantages described above with reference to offloading of transmission and processing burdens from lower-resource networks and devices, but also is advantageous in developing applications, in that code from a certain instance of a conduit for supporting a particular application may often be duplicated and then modified in relatively minor ways to create a new application-specific conduit for supporting a new software application. For example, an application conduit configured to gather information from Twitter, Linked In and Facebook relating to person X in support of an application about person X may be easily modified to gather information from those same data sources relating to person Y in support of a new application about person Y.

Similarly, an existing version of a conduit for supporting an existing version (version 1.0) of a software application may be modified in relatively minor ways to create a new version of the conduction for supporting a newer version (version 2.0) of the same software application, and each conduit version may provide only the necessary data for each version of the software application, and both conduits and both applications may be supported simultaneously via a single instances of the normalization engine 110. This may be particularly advantageous in mobile computing environments in which it is commonplace for multiple versions of software applications to be deployed and in use concurrently.

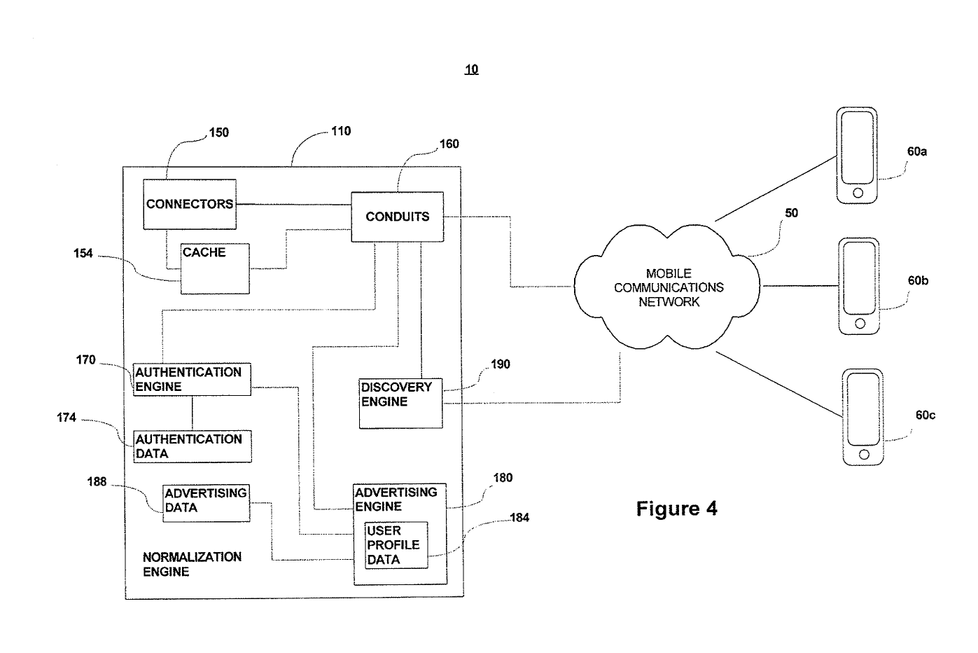

In certain embodiments, the normalization engine further provides additional functionality, as shown in FIG. 4. Referring now to FIG. 4, an embodiment of the normalization engine is shown that includes not only connectors 150 and conduits 160, but further includes a memory cache 154. In an exemplary embodiment, at least one conduit 160 includes instructions for selectively caching normalized data in the memory cache 154 of the normalization engine 110. The instructions may be provided as JavaScript scripting stored in the memory of the normalization engine and executed as necessary by the conduits within the content server system.

For example, the instructions may provide for caching the results from executing GET actions from three separate connectors and compiling the three responses into one single normalized JSON response to be stored for the following 30 minutes. In an alternative embodiment, at least one source-specific connector 150 includes instructions for selectively caching received data in the memory of the normalization engine. For example, the instructions may provide that an RDBMS connector specify that the result of a GET action be stored for the following 30 minutes. Such caching permits storage of data likely to be subsequently requested by the same or another client devices, and permits delivery of such data in response to a request for same without a need to repeat the processing required to initially obtain it.

By way of further example, instructions may provide that data be cached as a function of device-specific information, such as geographic location information. For example, instructions may provided that data will be cached at a particular instance of the normalization engine based upon the geographic location of that instance of the normalization engine and/or the client device. For example, information from a blog may contain information about the Statue of Liberty and may have such information stored at a normalization engine located proximate to New York City, and/or may store information for production to client devices proximate to New York City. Proximity storing and/or production of aggregated third party information may allow for improved access to content by the client devices.

As can be appreciated by those skilled in the art, the caching of content may allow for multiple devices to access the same content repeatedly and allow for a majority of the content to remain resident within the normalization engine without repeated re-conversion or regeneration for repeated upload—thus, conserving local client device memory and processing resources, and the bandwidth available between the client devices, the normalization engine, and third party content.

In certain embodiments, the conduit may also provide recommendations and/or instructions as to how normalized data transmitted to a client device should be cached on that client device. For example, while configuring a conduit for returning data on open job positions, the conduit may be configured to specify that the client device consuming this information should cache it locally for one hour, and such information may be passed to the requesting application on the client device. Subsequent requests by that client device for information relating to the same open job position will thus result in the client device's retrieval of the necessary information from the client device cache, rather than from the content server. This is advantageous, because it moves data management away from resources that are slow and scarce (e.g., network bandwidth within the mobile communications network) towards resources that are faster and more available (e.g., storage space on the client device).

Any suitable logic, methodology algorithm and/or criterion may be used for determining which information to cache, how long to retain it, etc. Suitable techniques are known in the art and the particular methodology used is beyond the scope of the present invention.

In the exemplary embodiment shown in FIG. 4, the normalization engine 110 further includes an authentication engine 170 for authenticating a user and/or client device requesting data. The authentication engine 170 comprises instructions for permitting access to data stored in at least one data store by a client device only if access by the client device can be authenticated as a function of data received at the normalization engine 110. In the exemplary embodiment shown, authentication data 174 is stored in the memory of the normalization engine 110 and may be stored and used for authentication purposes in accordance with various authentication techniques known in the art and beyond the scope of the present invention. In alternative embodiments, the authentication engine does not store authentication data required for authentication but rather communicates via a communications network with other computing systems providing authentication services, e.g., using LDAP or OAUTH integration, as well known in the art.

In the exemplary embodiment shown in FIG. 4, the normalization engine 110 further includes an advertising engine 180. In the exemplary embodiment shown, the normalization engine 110 further includes advertising data 188 stored in its memory, though in alternative embodiments the advertising data may be stored outside of the normalization engine. The advertising engine 180 includes instructions for providing relevant advertising data to a client device 60a, 60b, 60c. The advertising engine 180 includes instructions for selecting relevant advertising data for delivery to a specific user/client device from among the stored advertising data 188 as a function of profile data 184 stored in association with a profile associated with a particular client device. For example, user profile, usage, demographic, device type (e.g., OS) and/or other data may be tracked, compiled, catalogued, and stored for a particular authenticated user authenticated by the authentication engine. Alternatively, information associated with a specific client device connecting to the normalization engine may be gathered and/or logged as a function of data transmitted to that client device via the normalization engine (e.g., from a particular data store), including the device type (or OS type) and location information of that user/client device. That information, once gathered on a per-client device basis, may then be used to draw inferences and/or to otherwise select relevant advertising data for delivery to the corresponding user/client device.

In the exemplary embodiment shown in FIG. 4, the normalization engine 110 further includes a discovery engine 190. The discovery engine 190 comprises instructions for compiling a list of conduits 160 available at the normalization engine 110 and for exposing the list via the communications network. By way of example, the list may be exposed in a REST or other web services communication. The discovery engine may be configured to periodically update the list of available conduits. In this manner, an inventory of conduits may be made known and various mobile client devices may detect which conduits are available, which authentication schemes are required, and what data schema is expected to communication with those conduits, so that software developers and software development tools seeking to build applications that will use these conduits can discover which conduits are available along with the requirements and development dispositions for these conduits.

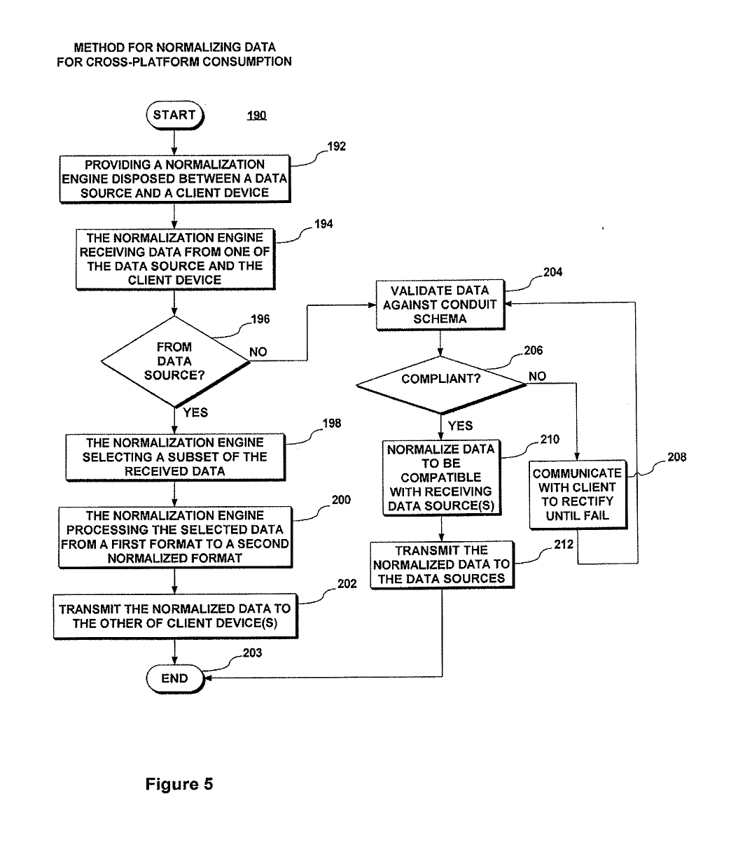

In use, the exemplary normalization engine may be used as shown in the exemplary method shown in FIG. 5. Referring now to FIG. 5, the flow diagram 190 illustrates an exemplary method for normalizing data for cross-platform consumption by heterogeneous computing devices in a communications network. As shown at 192, the method begins with providing a normalization engine 110 disposed logically between a data source 20a, 20b, and 22a-22n and at least one client device 60a, 60b, 60c, etc. See FIGS. 1, 2 and 3. By way of example, this may involve configuring distinct content server hardware with special-purpose normalization engine software consistent with the present invention and operably connecting the content server with a public or private communications network, e.g., using conventional Internet or other communications network hardware and software.

By way of alternative example, this may involve a distributed set of content servers, each running the normalization engine software as a single-process that shares microprocessor resources with other distributed applications on that server. In this context, among these distributed servers is a set of persistent servers used to store and coordinate persistent data among the normalization engines (e.g. cached request data, configuration data, etc.) This distributed set of content servers is connected to a public or private communications network, e.g., using the conventional Internet or other communications network hardware or software. As requests arrive, the communications network coordinates redirects requests such that one of the distributed set of content servers processes the request using its hosted instance of the normalization engine, thus fulfilling the request.

Hardware, software and technologies for operably connecting a server or other computing process to a communications network are well known in the art and thus are not discussed in detail herein.

Next, the exemplary method involves the normalization engine's receipt of data, as shown at 194. The data may have any suitable structure and represent any suitable content. In this example, this involves receipt at the normalization engine of data from a data source. Accordingly, the data may be initially received at a data source connector 150a-150n of the normalization engine 110, as shown in FIG. 3. In other embodiments, this may involve receipt at the normalization engine of data from a client device. In such embodiments, the data may be initially received at an application-specific conduit 160a, 160b, etc. of the normalization engine 110, as shown in FIG. 3. Accordingly, it should be appreciated that communication via the normalization engine is bidirectional in nature. As discussed herein, data connections and communications between the normalization engine and data sources may be made via an HTTP or other connection, and communications between the normalization engine and the client devices may be made via a REST web service communication.

Next, it is determined at 196 whether the data was received from a data source (intended for receipt by client computing devices) or was received from client computing devices (and intended for receipt by data sources) 214. Notably, this step may be performed by drawing inferences while performing other parts of the exemplary process.

If it is determined at 196 that data is flowing from a data source to a client device, then the normalization engine selects a subset of the received data, as shown at 198. In modes in which data is being communicated from a data source to a client device, the subset may be a small fraction of the original data. In modes in which data is being communication from a client device to a data source, the selected subset may be substantially all or all of the original data. As discussed above, conduits (which in fact may include groups of conduits) are created to communication with a specific software application running on a client device. Accordingly, this is performed by the conduit corresponding to the software application requesting the data. That corresponding conduit is created or designed in tandem with the application so as to be aware of the information that is required by the requesting application.

The selection shown at 198 may involve receiving communication parameters, such as an IP address and access information, from the client device, and passing those communication parameters to an appropriate connector for connecting to a data source storing the required information. The connector is configured to accepting communication parameters, and for executing actions against a corresponding data source. For example, an RDBMS connector may include instructions permitting the connector to GET data from relational databases, and the conduit may provide the connector with information as to which relational database to GET information from, as identified by the communication parameters. Notably, the connector may receive significantly more data than is required by the software application, and the instructions contained in the conduit, and executed by the conduit alone or in conjunction with the connector, may allow for selecting an appropriate subset of the received data for responding to the software application's request.

Notably, the conduit may include instructions for retrieving and selecting data from multiple different data sources. Thus, a single application's conduit may in fact include multiple sub-conduits, each of which is designed to gather information via a different connector. In this case, the selected subset of information may include data aggregator from multiple data sources.

The selected data gathered is inherently in the native format in which it was available for gathering from the various data sources, and with the exception of relational databases, is provided with a level of granularity defined by the data source, without regard to the specific portions of data that may be required for any particular software application. Accordingly, after selecting the data that is required for a response to the request, the normalization engine then processes the selected data from a first format (which may include different portions of data, each in a distinct format) to a second format, as shown at 200. Generally, the first format may be incompatible (in an absolute sense or from in an efficiency sense) with the client devices. In contrast, the second format is selected to be a format that is compatible with the client or other devices to be supported by the application server. Thus, the application server processes the selected data to provide normalized data in a predetermined fashion, namely, in a fashion suitable for consumption by the supported devices.

In certain embodiments, the specific predetermined fashion to be used may be determined dynamically, on a per-request or per-device basis, such that the specific fashion used in any particular instances is a function of the identity and type of device making a request and/or for which the data is being consumed. In one embodiment, the determination of a specific fashion is made dynamically by detecting the type of device consuming the data and tailoring the returned data according to the limitations for that device. For example, if an Apple iOS device incapable of consuming Adobe Flash video content makes a request for data include Adobe Flash video, then the normalization server, aware of such a limitation, would normalize the data by converting the Flash video to MP4 format. By way of example, the second format is preferably a JSON-formatted communication or an XML-formatted communication, due to the exceptionally-broad compatibility of computing devices with such communications. Such normalized data is thus normalized for consumption by a broad range of computing devices.

Next, the normalization engine exposes the processed data as normalized data in the second format for consumption by heterogeneous client devices via the communications network, as shown at 202, and the method ends, as shown at 203. By way of example, this involves exposing the normalized data via one or more REST web services.

It should be appreciated that this method allows for efficient use of network and device resources. By way of example, this method allows data stored in data sources accessible by broadband networks to be provided to mobile computing devices accessible by resource-constrained mobile communications networks, by causing use of a broadband network to transmit large amounts of data from the data source to the normalization engine, by causing the normalization engine to identify the subset of information required by the client device, by causing the normalization engine to process the data into a broadly-compatible format, and then by delivering an amount of data that is reduced relative to what the data source itself would have provided, and by delivering that amount of data in a format that is compatible or more compatible (e.g., more compact, or more efficiently processable) to the mobile computing device(s) that request it.

If it is determined at 198 that the data is not from a data source, i.e., the flow of information is from a client device to one or more data sources, then the conduit executes instructions/scripting to validate the received data, as shown at 204. For example, this may involve validating data against a schema known to the conduit for the specific data received.

If the validation process determines that the received data is non-compliant at 206, then the conduit continues communication with the client device to rectify any deficiencies, as shown at 208. This may continue for a certain number of attempts, time, or in some otherwise limited fashion, after which the method may end.

If it is determined at 208 that the received data is compliant, then the conduit processed the data into normalized data in a predetermined fashion so that it is compatible with intended data source recipients (e.g., into the native format(s) of the various data source(s) that are intended to receive the data), as shown at 210. The normalized data is then transmitted to the data sources, as shown at 212, and the method ends.

Thus, an operator of a normalization engine may provide an instance of a normalization engine that includes connectors capable of establishing and conducting end-to-end communication with various types of data sources. The operator of the normalization engine may then permit application developers to create customized software applications for execution on various heterogeneous client devices in a manner that involves creation and storage at the normalization engine of a corresponding, customized conduits for those software applications that will configure and use the existing connectors for delivering data from specific data sources to specific software applications in accordance with instructions provided in the respective conduits. When a user of a client device executes one such application on a client device, the client device connects to the appropriate conduit of the normalization engine, which then communicates with the appropriate connectors of the normalization engine to establish communication sessions with and gather data as necessary from various data sources. The normalization engine then processes the received data in accordance with instructions provided in the conduit, and then exposes the processed data to a communications network for consumption by the client device/application, and other client devices executing the same application, preferably in a manner that is suitable for consumption by heterogeneous client devices, e.g. by converting selected data to cross-platform compatible code format (such as JSON or XML) regardless of the native format of any received data, and then exposing the data in a cross-platform compatible manner, e.g., via a REST web service.

FIG. 6 illustrates another exemplary method 220 for normalizing data for cross-platform consumption by heterogeneous computing devices in a communications network. The normalization engine may be provided as resident in content server hardware, and is provided within a network logically interposed between at least one client computing device and at least one data source. In this example, information is described as flowing from a data source to a client computing device. As shown at 222, the method begins with providing a normalization engine 110 including data source connectors for connecting to data sources and application-specific conduits for exchanging data with client device applications. More specifically, the method involves providing a normalization engine including conduits for supporting a specific application, using one or more connectors, some of which may be pre-existing, others of which may be created specifically to support the supported application.

By way of example, consider that a user of the normalization engine (e.g., a customer of an owner/operator of the normalization engine) wants to enable heterogeneous client devices to support a software application requiring retrieval of certain transaction data, namely, a single transaction containing the date, ID number, and total amount of the transaction, and a list of all of the items (including price and description) purchased as part of that transaction. In this example, such data is contained in the following systems within a secure private network: (a) an Oracle relational database that contains many tables, including one table that contains data specific to a transaction, and another table that specifies which items were purchased with each transaction; and (b) a comma-separated values (CSV) file that contains the detailed information about an item, including its description and price. Given this scenario and source data, the user would deploy and configure the following connectors to access these data sources: (a) the Relational Database (RDBMS) Connector to access the Oracle relational database; and (b) the CSV Connector to access the CSV file containing the item information. In this example, the user will configure the RDBMS connector 150d with the host name, port, and account information necessary to access the Oracle database, by configuring the application and/or conduit to pass such information to the generic RDBMS connector as communication parameters. In certain embodiments, the connector code is generic to one or more data sources of a single type, but maintains stored sets of configurations, each of which defines the connection to one particular data source and handles all communication with that particular data source, such that there is a one-to-one correlation between data sources and a particular configured instance of the connector. The RDBMS connector 150 provides the GET, CREATE, DELETE, and UPDATE actions for conduits to use. Further, the user will configure the CSV connector to access the CSV file containing the item information. This connector will be configured with the network location from which to download the file, which will be passed from the application and/or conduit to the connector as communication parameters. Thus, the CSV connector provides the GET action for conduits to use.

The user would then configure an application-specific conduit for this information, namely, a conduit that accepts a single argument (the id number of the transaction being requested) and returns just the information needed by the consumer—the transaction's date, id number, total value, along with a list of the price and description of all items purchased. The conduit is further configured to automatically authenticate the requestor, execute the series of connector actions required to retrieve this information, select and normalize a subset of this information, cache data on the content server as configured, and recommend that data be cached on the client device as configured. Further, if desired, the user would configure the conduit to normalize the selected data to a cross-platform compatible format (e.g., JSON-formatted data), and to expose the normalized data in a cross-platform compatible manner, e.g., via a REST web service.

The normalization engine 100 then receives from a requesting application (e.g., 70g, FIG. 3) running on a requesting client device (e.g., 60a) a request for specific data, such as data required to populate a particular application display screen to be displayed at the client device 60a during execution of the application 70g, as shown at 224. In this example, this request is received via the mobile communications network 50, and is communicated to the application-specific conduit 160c that was developed by software developers in tandem with development of application 70g for this purpose. For example, the request may be received at the application-specific conduit 160a in the form of an HTTP request received by the application-specific conduit 160a by virtue of REST web-service call hard-coded into the application 70g. Thus, the requested application's code includes configuration information that specifies the specific URL endpoints at which the normalization engine exposes its REST web services (as defined by its conduits).

The application may exchange JSON messages through REST web services such that the JSON messages observe the schemas defined by the normalization engine. Stated differently, each conduit is designed to have a unique schema that it will normalize all normalized messages to follow, both inbound and outbound. If an application is sending JSON data to the REST service defined by that conduit, it needs to follow the schema expected for that JSON data as defined by that conduit. Otherwise, the conduit will reject it as part of the validation process. If an application is receiving JSON data from the REST service defined by that conduit, it needs to know the schema so it knows what data is available, and where such data will be found in the response from the REST service.

Consistent with the “transaction data” example discussed above, in this step an application—via REST web-service call to the exposed REST web service for the relevant conduit—makes a request to the normalization engine for transaction with ID number “AAA001”. An example request REST HTTP request might be “GET http://testserver.testhost.com/api/v1/transaction/AAA0001”.

In this example, the application specific conduit 160c is configured to identify at least one data source connector for accessing data required to fulfill the request, as shown at 226. This configuration is specified by the normalization engine user/programmer in developing the conduit, who determines which data source connector actions that need to be executed by the conduit, in which order they need to be executed, what data is required to them to execute, and what subset of data needs to be retrieved from each action. For example, if the conduit needs to expose data from a relational database, the normalization engine user will specify that the conduit needs to execute the GET action of the RDBMS data source connector configured to communicate with that relational database, along with the data (specifically the query and filtering data) necessary to execute that GET action. In the case in which multiple data sources need to be accessed, the user will specify a series of actions for that conduit that will engage with each necessary data source connector. For example, if the user needs to update data to both a relational database and a document-based database, the user will update the conduit so that it first executes the UPDATE action of the RDBMS data source connector (passing in the necessary information), then executes the UPDATE action of the NoSQL data source connector (also passing in the necessary information.

In the context of the “transaction data” example discussed above, the relevant app-specific conduit is configured so that it will execute the following three actions against the two data source connectors that have configured for the system: (a) against the RDBMS Connector—GET FROM ORACLE DATABASE: SELECT FROM TRANSACTION TABLE WHERE TRANSACTION ID NUMBER=<to be defined>; and (b) against the RDBMS Connector—GET FROM ORACLE DATABASE: SELECT FROM TRANSACTION—ITEM MAPPING TABLE WHERE TRANSACTION ID NUMBER=<to be defined>, and for each entry returned from (b), (c) against the CSV Connector—GET FROM ITEM FILE: SELECT WHERE ITEM ID=<Item ID number from action (b)>.

In this embodiment, the conduit is not associated with a connector that is associated with only one data source, such as a specific web page. Rather, the conduit is associated with a connector that is associated with many data sources of a single type (such as relational databases). Accordingly, the connector must use information for connecting to the specific instance of a relational database that contains the data sought. Accordingly, in this example, the application-specific conduit 160c provides to the data source connector 150d communication parameters for retrieving data from the specific data source. For example, such communication parameters may include an IP address of the specific instance of the requisite database, login/access information, etc. Accordingly, next the conduit provides to the relevant connectors communication parameters necessary to access the relevant data sources, as shown at 228.

Next, the connector communicates with the corresponding data source identified by the communication parameters to retrieve/receive data from the data source, as shown at 230.

In the “transaction data” example, the conduit executes the three actions by engaging the correct data source connector (as specified in 226) and passing in the necessary data parameters (in this case, that the TRASACTION ID NUMBER is ‘AAA0001’) to execute the corresponding action. Further, the connectors execute the actions requested by the conduit. In this example, to execute the first action requested by the conduit the RDBMS Connector first issues the following PL/SQL call to the Oracle Database: SELECT TRANS_DATE, ID, TOTAL FROM TRANSACTION WHERE ID=‘AAA0001’. The results from this request are returned by the Oracle database to the connector, which then forwards the data to the conduit. The second action requested by the conduit is executed by the RDBMS Connector, which issues the following PL/SQL call to the Oracle Database: SELECT ITEM_ID FROM TRANSACTION_ITEM WHERE TRANS ID=‘AAA0001’. The results from this request are returned by the Oracle database to the connector, which then forwards the data to the conduit. The conduit then iterates through the list of information returned by the second action. For each item in that list, it requests that the CSV Connector execute the third action, which involves parsing the Item CSV file and returning the text content for all rows where the ID value is equal to an ITEM_ID retrieved in the second action.

Notably, as is conventional in the context of many client/server communications via the World Wide Web, this information is typically received in bulk, without a fine degree of granularity, and the resources of the client device are relied upon for further processing. In other words, in response to a request for data, a significant amount of data may be received, and that significant amount of data may be well in excess of the particular amounts of information required by the requesting application. This is a result of conventional programming techniques and architectures that have been heretofore developed and are generally adapted for use in a network environment in which bandwidth resources and client computing resources are plentiful, as in today's current PC and World Wide Web environment.

Next, the application-specific conduit 160c selects a subset of the received data, as shown at 232. More specifically, the application-specific conduit 160c is configured to be aware of the specific data required by the application, and the conduit selects a subset of the data that is required for fulfilling the application's request for data, which may allow for much of the received data to be excluded from the selected subset. This is performed in accordance with instructions contained at the conduit, and provided at the conduit by a developer of the conduit, knowing the data requirements of the companion application 70g.

Thus, the conduit filters through all of the data returned from the data source connectors in 230, and selects only the subset of that data that should be exposed to the client device (as configured within the conduit). In the context of the “transaction data” example, this subset includes only the Date, ID, and Total for the transaction, as well as the Price and Description for each item associated with that transaction. Optionally, the conduit also caches data as necessary for future requests.

The application-specific conduit 160c then processes the selected data into normalized data in a predetermined format compatible with the requesting device, as shown at 234. This predetermined format may be defined as a hard-coded format universal as to all devices intended to be supported by the normalization engine, e.g. such as a JSON formatted communication. Alternatively, this predetermined format may be determined on a per-device or per-request basis. For example, if the requesting device is determined by the conduit to be a device running Apple's iOS operating system, then the normalization engine will be configured to process selected data into a first format, wherein is may be configured to processed selected data into a different format for a different device running a different operating system.

In the context of the transaction data example, the conduit takes all of the data returned by 232 and normalizes it as a JSON-formatted response message ready to return to the client device via an HTTP REST response. For the current example, the JSON content would display as follows:

```
  {
    “total rows”: 1,
    “display_rows”: 1,
    “offset”: 0,
    “id”: “http://testserver.testhost.com/api/v1/AAA0001”,
    “rows”: [
      {
        “transaction_id”: “AAA0001”,
        “date”: “2011-11-13T09:32:44Z”,
        “total”: “$132.39”,
        “items”: [{
          “description”: “NIKON CLR340”
            “Price”: “119.99”
        }{
          “description”: “16GB SD Card”
            “Price”: “12.40”
        }]
      ]
}
```

Next, the application-specific conduit exposes the normalized data to a communications network for consumption by the requesting device, as shown at 236, and the method ends, as shown at 237. By way of example, such exposing of the normalized data may be provided via one or more REST web services communications. In that case, the application 70g may be caused to access that normalized data by programmers configuring the application 70g to make HTTP requests against the URL corresponding to the conduit's REST web services and to parse the JSON content returned thereby. Thus, the JSON-formatted data is returned to the client device via an HTTP REST response over a communications network.

The normalized data may also include instructions as to how the client device should handle this data—including the length of time during which the information should be stored locally on the device. The software application at the client device can use this information to then execute the recommended instructions.

It will be appreciated by those skilled in the art that due to the nature of such exposing of data via REST web services, the normalized data exposed for that specific application 70g could also be consumed by a different application by configuring the different application to consume such data in a similar manner. It should be noted that due to differences between the application 70g and the different application, some of the efficiencies of using a different application-specific conduit for the different application may be lost. However, in certain instances the advantages of avoiding development of a new application-specific conduit may outweigh the disadvantages of using an existing conduit for another application, and may still provide improved efficiency relative to accessing the data sources absent the normalization engine and its related processing efficiencies.

Though the normalization engine has been discussed above and/or illustrative for illustrative clarity with reference primarily to a single instance of discrete server hardware, it should be noted that in alternative embodiments the normalization engine may be provided or controlled on a per-enterprise basis, or may be made available in a service format, in which third party developers are permitted to build and install conduits and/or connectors for use within another party's normalization engine. By way of example, a software development kit (SDK) may be provided that may be used by third parties to create conduits in conjunction with applications created by those third parties, and those conduits may then reside on an instance of the normalization engine controlled by another party.

FIG. 7 depicts an exemplary computing system 300 that can be used in accordance with system and methods described herein. Computing system 300 is capable of executing software, such as an operating system (OS) and a variety of computing applications 390. The operation of exemplary computing system 300 is controlled primarily by computer readable instructions, such as instructions stored in a computer readable storage medium, such as hard disk drive (HDD) 315, optical disk (not shown) such as a CD or DVD, solid state drive (not shown) such as a USB “thumb drive,” or the like. Such instructions may be executed within central processing unit (CPU) 310 to cause computing system 100 to perform operations. In many known computer servers, workstations, personal computers, mobile devices, and the like, CPU 310 is implemented in an integrated circuit called a processor.

It should be appreciated that, although exemplary computing system 300 is shown to comprise a single CPU 310, such description is merely illustrative as computing system 300 may comprise a plurality of CPUs 310. Additionally, computing system 300 may exploit the resources of remote CPUs (not shown), for example, through communications network 370 or some other data communications means.

In operation, CPU 310 fetches, decodes, and executes instructions from a computer readable storage medium such as HDD 315. Such instructions can be included in software such as an operating system (OS), executable programs, and the like. Information, such as computer instructions and other computer readable data, is transferred between components of computing system 300 via the system's main data-transfer path. The main data-transfer path may use a system bus architecture 305, although other computer architectures (not shown) can be used, such as architectures using serializers and deserializers and crossbar switches to communicate data between devices over serial communication paths. System bus 305 can include data lines for sending data, address lines for sending addresses, and control lines for sending interrupts and for operating the system bus. Some busses provide bus arbitration that regulates access to the bus by extension cards, controllers, and CPU 310. Devices that attach to the busses and arbitrate access to the bus are called bus masters. Bus master support also allows multiprocessor configurations of the busses to be created by the addition of bus master adapters containing processors and support chips.

Memory devices coupled to system bus 305 can include random access memory (RAM) 325 and read only memory (ROM) 330. Such memories include circuitry that allows information to be stored and retrieved. ROMs 330 generally contain stored data that cannot be modified. Data stored in RAM 325 can be read or changed by CPU 310 or other hardware devices. Access to RAM 325 and/or ROM 330 may be controlled by memory controller 320. Memory controller 320 may provide an address translation function that translates virtual addresses into physical addresses as instructions are executed. Memory controller 320 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, content server computing system 300 may contain peripheral controller 335 responsible for communicating instructions using a peripheral bus from CPU 310 to peripherals, such as printer 340, keyboard 345, and mouse 350. An example of a peripheral bus is the Peripheral Component Interconnect (PCI) bus.

Display 360, which is controlled by display controller 355, can be used to display visual output generated by computing system 300. Such visual output may include text, graphics, animated graphics, and/or video, for example. Display 360 may be implemented with a CRT-based video display, an LCD-based display, gas plasma-based display, touch-panel, or the like. Display controller 355 includes electronic components required to generate a video signal that is sent to display 360.

Further, computing system 300 may contain network adapter 365 which may be used to couple computing system 300 to an external communication network 370, which may include or provide access to the Internet, and hence which may provide or include tracking of and access to the domain data discussed herein. Communications network 370 may provide user access to computing system 300 with means of communicating and transferring software and information electronically, and may be coupled directly to computing system 300, or indirectly to computing system 300, such as via PSTN or cellular network 380. For example, users may communicate with computing system 300 using communication means such as email, direct data connection, virtual private network (VPN), Skype or other online video conferencing services, or the like. Additionally, communications network 370 may provide for distributed processing, which involves several computers and the sharing of workloads or cooperative efforts in performing a task. It is appreciated that the network connections shown are exemplary and other means of establishing communications links between computing system 300 and remote users may be used.

It is appreciated that exemplary computing system 300 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

It is again emphasized that the discussion above is for illustrative purposes only, and is not limiting. By way of example, the normalization engine may be delivered via a SaaS in a distributed cloud-based (i.e., networked thin client-based) computing environment. Further, it should be appreciated that such normalization may occur in whole or in part and that the normalization engine contemplated herein is readily scalable to accommodate varying levels of content, application feeds and/or content feeds. Further, it should be noted that although a conduit may be designed specifically for a single software application, or even for multiple software applications, that it is technologically feasible to use to advantage that same conduit for a different software application, and nothing in the description or claims herein shall be construed as limiting in this regard.

Further, it should be noted that the normalization engine may be used to filter content and convert and restrict content as required by each client device, or as predetermined by the normalization engine. For example, this maybe achieved by the conduit in selecting data. Using metadata contained in the data may allow the normalization engine to rate content using a scale such as the one used by the Motion Picture Association of America. Specifically, content might be rated as G, PG, R, or X. Using keyword associations and metadata indicators which may provide previous ratings by third party content providers, the normalization engine may thereby limit access to certain rated content. For example, some providers of client devices and operating systems that limit or deny access to content rated R and/or X may so indicate to the normalization engine. The normalization engine, after identifying the client device seeking access to content, may provided such content restriction. Similarly, the normalization engine may, upon handshaking with the client device, discover parameters regarding the information which may be accessed, such as, for example, through parental control programmed into the client device. For example, the selecting of data at the conduit may provided that, for example, members of an “officer manager” group would not have access to data store content pertaining to health records, but that members in a “doctor” group would have such access.

Processing of data at the normalization engine may also include encrypting the normalized data before providing it to a client device. For example, many of the existing platforms discussed above do not comply with certain encryption certificates such as, for example, HL7 for the transmission of health care related data. An application may reside on the client device that may encode/decode the information passed between the client device and the normalization engine. The encryption may be provided as an extra layer on top of already encrypted information, or may be used as the single source of encryption (although such a source may have multiple layers). The encryption used may be any of those known to those skilled in the art, may be asymmetric and/or symmetric encryption, for example, and may also be used between the third party content providers and the normalization engine. This may be used to advantage, for example, in protecting the confidentiality of HIPAA-related data.

For example, providing encryption between the client device and the third party content equal to or greater than that required for the electronic transmission of health care information may allow otherwise non-qualifying devices to be used to send or receive such information. In addition, the receiving party, for example a hospital, may not be restricted to a single platform or device provider, as the encryption provided by the normalization engine may be independent of device and/or OS.

By way of further example, a doctor may use one or more tablet devices from various manufacturers and may have increased interaction with information otherwise not available outside the hospital's secure network. This may allow the doctor to more efficiently conduct business and may allow the doctor to receive alerts, for example, when patient information is ready for review or there is critical information available, for example. Secure electronic access to information may allow the doctor and/or his staff to forgo slower means of communication such as facsimile transmission and reaching people via telephone, for example.

As will be apparent to those skilled in the art, the use of the normalization engine allows for the adaptation and development of applications and cloud-based services for use interchangeably between third parties client devices without the development of existing infrastructure. The present invention may be immediately deployable within an existing technology infrastructure and may provide for the communication between systems and devices not otherwise communicatively compatible.

The normalization engine may also be deployed to control local technology infrastructure and/or appliances communicatively coupled with at least one client device. For example, the content server can have a connector to a smart thermostat, which enables actions through which client devices can communicate with that thermostat and change its settings.

Similarly, small household appliances, consumer devices, and “smart” cars, for example, may also be controlled and communicated with as discussed above. For these applications where local computing capacity may be limited, the normalization engine provides virtually unlimited processing and storage, and may further facilitate the execution of commands and information gathering that would not be otherwise possible solely for the local device.

Those of skill in the art will appreciate that the herein described systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

What is claimed is:

1. A computer-implemented method for normalizing data for cross-platform consumption, the method comprising:
providing a normalization engine for normalizing data for cross-platform consumption, the normalization engine comprising a computer processor operatively connected to a memory for storing processor-executable instructions, and to a network adapter for communicating data via a communications network;
receiving data at the normalization engine via the communications network;
processing data, at the normalization engine, to provide normalized data in a predetermined fashion compatible with a plurality of heterogeneous devices; and
exposing the normalized data, for transmission by the network adapter via the communications network.

2. The method of claim 1, wherein said receiving data comprises receiving data from a data source for transmission to at least one of a plurality of heterogeneous client computing devices, the method further comprising:
selecting, at the normalization engine, a subset of the received data, the selected data being selected in accordance with instructions resident at the normalization engine, the selected data being processed to provide the normalized data.

3. The method of claim 2, wherein said receiving data comprises receiving data from a data source in a fashion that is incompatible for consumption by at least one of a plurality of heterogeneous client devices, and wherein said processing comprises processing the selected data to provide the normalized data in a fashion that is compatible for consumption by at least one of the plurality of heterogeneous client devices.

4. The method of claim 3, wherein said processing comprises processing the selected data to provide the normalized data in XML format.

5. The method of claim 4, wherein said exposing comprises exposing the normalized data via REST web services.

6. The method of claim 3, wherein said exposing comprises exposing the normalized data via SOAP.

7. The method of claim 3, wherein said processing comprises processing the selected data to provide the normalized data in JSON format.

8. The method of claim 7, wherein said exposing comprises exposing the normalized data in a web services communication.

9. The method of claim 8, wherein said exposing comprises exposing the normalized data via REST web services.

10. The method of claim 9, wherein said exposing comprises transmitting comprises transmitting the normalized data in the predetermined fashion to at least one of a plurality of heterogeneous client devices.

11. The method of claim 1, wherein said receiving data comprises receiving data from a client device for transmission to at least one of a plurality of heterogeneous data sources, the method further comprising:
validating, at the normalization engine, the received data for compliance with a predetermined schema, the validated data being processed to provide the normalized data.

12. The method of claim 11, wherein said receiving data comprises receiving data from a client computing device in a fashion that is incompatible for consumption by at least one of a plurality of heterogeneous data sources, and wherein said processing comprises processing the received data to provide the normalized data in a fashion that is compatible for consumption by at least one of the plurality of heterogeneous data sources.

13. The method of claim 12, wherein said receiving data comprises receiving data via a web service.

14. The method of claim 12, wherein said receiving data comprises receiving data via a REST web service.

15. The method of claim 12, wherein said exposing comprises transmitting comprises transmitting the normalized data via HTTP to at least one of a plurality of heterogeneous data stores.

16. The method of claim 1, wherein said providing the normalization engine comprises providing at least one data source-specific connector, each data source-specific connector being configured to exchange data with a corresponding data source via a first communications network.

17. The method of claim 16, wherein said providing the normalization engine comprises providing at least one software application-specific conduit, each application-specific conduit comprising instructions for selecting a subset of the received data.

18. The method of claim 1, wherein said receiving data comprises receiving data from a plurality of data sources and aggregating the data from the plurality of data sources into the received data.

19. The method of claim 1, further comprising caching normalized data in the memory of the normalization engine.

20. The method of claim 1, wherein the normalization engine further comprises an authentication engine, the method further comprising the authentication engine permitting access to data stored in at least one data store by a client device only if access by the client device can be authenticated as a function of data received at the normalization engine.

21. The method of claim 1, wherein the normalization engine further comprises an advertising engine, the method further comprising the advertising engine storing advertising data and providing relevant advertising data to a client device, the relevant data being select from among advertising data as a function of data associated with the client device.

22. The method of claim 1, wherein the normalization engine further comprises a discovery engine, the method further comprising the discovery engine compiling a list of connectors available at the normalization engine and exposing the list via the communications network.

23. A normalization engine for normalizing data for cross-platform consumption, the normalization engine comprising:
at least one data source-specific connector, each data source-specific connector being configured to exchange data via a communications network with at least one data source; and
at least one software application-specific conduit, each application-specific conduit being configured to communicate with at least one connector, and to exchange data via a communications network with at least one of a plurality of heterogeneous client computing devices, each application-specific conduit comprising instructions for processing received data to provide normalized data in a predetermined fashion compatible an intended recipient of the data, and for exposing the normalized data via the communications network.

24. The normalization engine of claim 23, wherein said at least one application-specific conduit is configured to receive the received data from at least one of a plurality of heterogeneous client devices, and wherein said at least one application-specific conduit comprises instructions for processing the received data to provide normalized data in a predetermined fashion compatible with at least data source intended to receive the data via the communications network.

25. The normalization engine of claim 23, wherein said at least one data source-specific connector is configured to receive the received data from a corresponding data source, and wherein said at least one software application-specific conduit comprises instructions for selecting a subset of the received data for exposure via the communications network.

26. The normalization engine of claim 25, wherein said at least one application-specific conduit is configured to provide the normalized data in JSON format.

27. The normalization engine of claim 26, wherein said at least one application-specific conduit is configured to provide the normalized data via a REST web service.

28. The normalization engine of claim 23, wherein said at least one data source-specific connector is configured for communication with a plurality of distinct data sources of a similar data type.

29. The normalization engine of claim 23, wherein said at least one application-specific conduit is configured for communication with a plurality of data source-specific connectors.

30. The normalization engine of claim 23, wherein said at least one software application-specific conduit comprises application-specific instructions for aggregating data received from a plurality of data sources, and for exposing normalized data selected from the aggregated data to at least one of the plurality of heterogeneous client devices.

31. The normalization engine of claim 23, wherein said normalization engine further comprises a memory cache, and wherein said at least one data source-specific connector comprises instructions for selectively caching received data in the memory of the normalization engine.

32. The normalization engine of claim 23, wherein said normalization engine further comprises an authentication engine, said authentication engine comprising instructions for permitting access to data stored in at least one data store by a client device only if access by the client device can be authenticated as a function of data received at said normalization engine.

33. The normalization engine of claim 23, wherein said normalization engine further comprises advertising data stored in its memory and an advertising engine, said advertising engine instructions for providing relevant advertising data to a client device authenticated by the authentication engine, said advertising engine comprising instructions for selecting relevant advertising data from said advertising data.

34. The normalization engine of claim 23, wherein said normalization engine further comprises a discovery engine, said discovery engine comprising instructions for compiling a list of connectors available at said normalization engine and for exposing the list via the communications network.

35. The normalization engine of claim 19, wherein said discovery engine is configured to expose the list in via a REST web service.

36. A content server for normalizing data for cross-platform consumption, the content server comprising:
a microprocessor for executing microprocessor-executable instructions;
a network adapter operatively connected to the microprocessor for communicating data via a communications network;
a memory operatively connected to the microprocessor for communication therewith, the memory storing microprocessor-executable instructions for causing the content server to:
receive data at the content server via the communications network, the received data being incompatible with a plurality of devices intended to receive the data;
process, at the content server, the data to provide normalized data in a predetermined fashion compatible with the plurality of devices; and
transmit, from the content server via the communications network, the normalized data to at least one of the plurality of devices.

37. The content server of claim 36, wherein said received data is received from a data source for transmission to at least one of a plurality of heterogeneous client computing devices, the content server further storing in its memory microprocessor-executable instructions for causing the content server to:
validate, at the content server, the received data for compliance with a predetermined schema, the validated data being processed to provide the normalized data.

38. A system for normalizing data for cross-platform consumption, the content server comprising:
a plurality of heterogeneous client devices, each of the plurality of heterogeneous client devices storing a software application for consuming data from data sources; and
the content server of claim 36.
